(19) United States
(12) Patent Application Publication
(10) Pub. No.: US 2007/0086354 A1
(43) Pub. Date: Apr. 19, 2007

(54) Method and apparatus for performing a bit error rate test, and for configuring the receiving or transmitting end of a communication link

(76) Inventor: Bruce Alan Erickson, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/253,241

(22) Filed: Oct. 17, 2005

(51) Int. Cl. H04J 1/16; H04Q 7/00

(52) U.S. Cl. 370/252; 370/333

(57) ABSTRACT

In one embodiment there is provided a method for performing a bit error rate test. In accord with the method, a bitstream generated in accord with a predetermined algorithm is sent via a transmitting end of a communication link. The bitstream is then received via a receiving end of the communication link; and, for each of a number of bit sets in the received bitstream, i) a first number of bits in the bit set, and the predetermined algorithm, are used to predict a second number of bits in the bit set, and ii) a bit error rate for the received bitstream is determined, in part, by comparing the predicted second number of bits to a corresponding second number of bits in the bit set. Other embodiments are also disclosed.

### BACKGROUND

One way to characterize a communication link is via a bit error rate test. Typically, a bit error rate test is conducted by coupling a bit error rate tester (BERT) to both the transmitting and receiving ends of a communication link. The BERT then 1) provides a bit pattern to the transmitting end of the communication link, and 2) compares the bit pattern provided to the transmitting end of the communication link to a bit pattern acquired from the receiving end of the communication link. In order to synchronize the bit error rate test, the BERT provides a common reference clock to both the transmitting and receiving ends of the communication link.

### SUMMARY OF THE INVENTION

In one embodiment, a method for performing a bit error rate test comprises, via a transmitting end of a communication link, sending a bitstream that is generated in accord with a predetermined algorithm. The bitstream is then received via a receiving end of the communication link; and, for each of a number of bit sets in the received bitstream, i) a first number of bits in the bit set, and the predetermined algorithm, are used to predict a second number of bits in the bit set, and ii) a bit error rate for the received bitstream is determined, in part, by comparing the predicted second number of bits to a corresponding second number of bits in the bit set.

In another embodiment, a method for determining one or more acceptable analog characteristics for a communication link extending between a transmitting end and a receiving end comprises, during one or more setup phases, 1) syncing a receive clock of the receiving end to signal edges recovered from the communication link; 2) sending a plurality of multi-bit data characters via the transmitting end; and 3) via the receiving end, segmenting received bits into data characters in accord with a data character window and, after syncing the receive clock, shifting the data character window with respect to the received bits until the data characters it produces coincide with one or more of the multi-bit data characters sent by the transmitting end of the communication link. The method further comprises sending, via the transmitting end of the communication link, a plurality of bitstreams that are generated in accord with a predetermined algorithm. The bitstreams are sent during one or more test phases of the method. Also during the one or more test phases, and via the receiving end of the communication link, 1) each bitstream is received; and 2) for each received bitstream, and for each of a number of bit sets in the received bitstream, i) a first number of bits in the bit set, and the predetermined algorithm, are used to predict a second number of bits in the bit set, and ii) a bit error rate for the received bitstream is determined, in part, by comparing the predicted second number of bits to a corresponding second number of bits in the bit set. The method further comprises, during the one or more setup phases, and between sending each of the plurality bitstreams, altering at least one analog characteristic of the transmitting or receiving end of the communication link. Finally, and in response to the bit error rates determined for different ones of the bitstreams, the transmitting or receiving end of the communication link is configured in accord with the at least one analog characteristic corresponding to an acceptable bit error rate.

In yet another embodiment, apparatus comprises a receiver and logic. The logic receives a first plurality of bitstreams via the receiver, each bitstream of which is generated in accord with a predetermined algorithm. For each received bitstream, and for each of a number of bit sets in the received bitstream, the programmed logic i) uses a first number of bits in the bit set, and the predetermined algorithm, to predict a second number of bits in the bit set, and ii) determines a bit error rate for the received bitstream, in part, by comparing the predicted second number of bits to a corresponding second number of bits in the bit set.

Other embodiments are also disclosed.

### BRIEF DESCRIPTION OF THE DRAWINGS

Illustrative embodiments of the invention are illustrated in the drawings, in which:

FIG. 1 illustrates a first exemplary method for performing a bit error rate test;

FIG. 2 illustrates an exemplary communication link over which the FIG. 1 method may be executed;

FIG. 3 illustrates a first exemplary operation of a portion of the FIG. 1 method;

FIG. 4 illustrates a second exemplary operation of a portion of the FIG. 1 method;

FIG. 5 illustrates a third exemplary operation of a portion of the FIG. 1 method;

FIG. 6 illustrates an exemplary method for determining one or more acceptable analog characteristics for a communication link such as that which is shown in FIG. 2; and

FIG. 7 illustrates the exemplary operation of a portion of the FIG. 6 method.

### DETAILED DESCRIPTION

As mentioned in the Background, a bit error rate test is typically synchronized by providing a common reference clock to both the transmitting and receiving ends of a communication link. However, there are times when a common reference clock cannot be provided. For example, Xilinx, Inc. (of San Jose, Calif.) offers cards on which multiple ROCKETIO™ transceivers are constructed, all of which share a common local clock. As a result, when ROCKETIO™ transceivers on different cards are coupled to form a communication link, there is no easy way to provide the transceivers on the different cards with a common reference clock (i.e., for the purpose of conducting a bit error rate test).

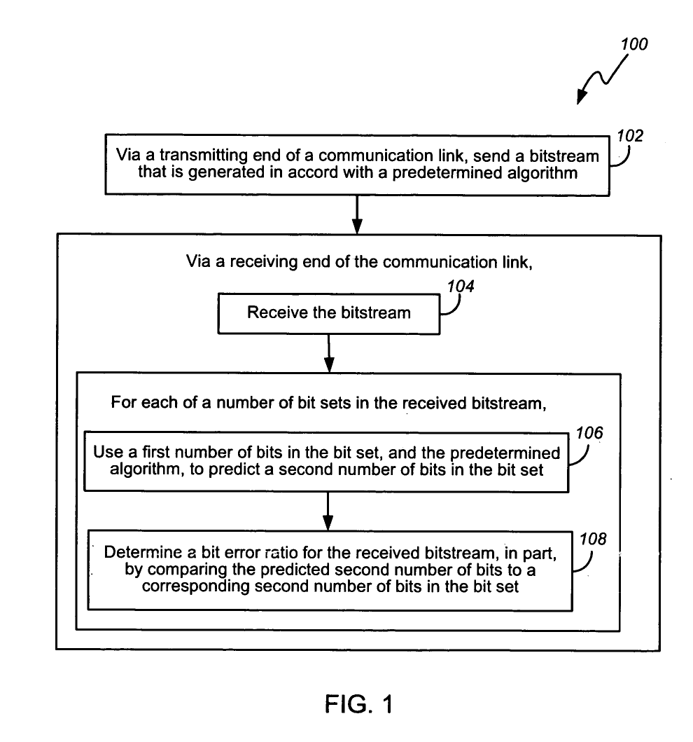

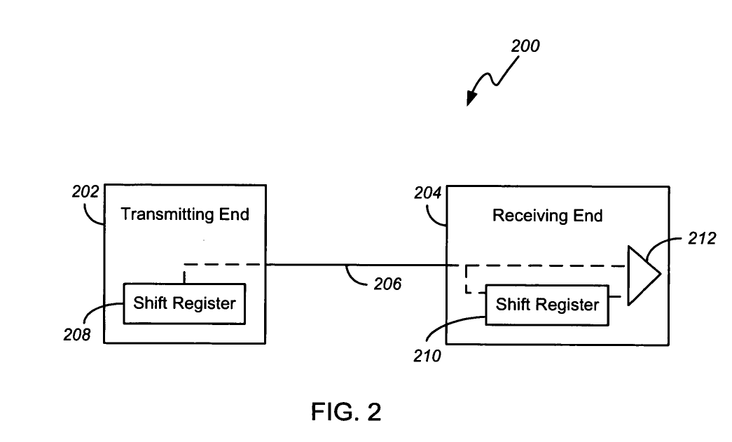

To enable the performance of a bit error rate test in the above and other contexts, FIG. 1 illustrates a first exemplary method 100 for performing a bit error rate test. The method 100 is performed for a communication link 200 that extends between a transmitting end 202 (e.g., a transmitter or transceiver) and a receiving end 204 (e.g., a receiver or transceiver). See FIG. 2.

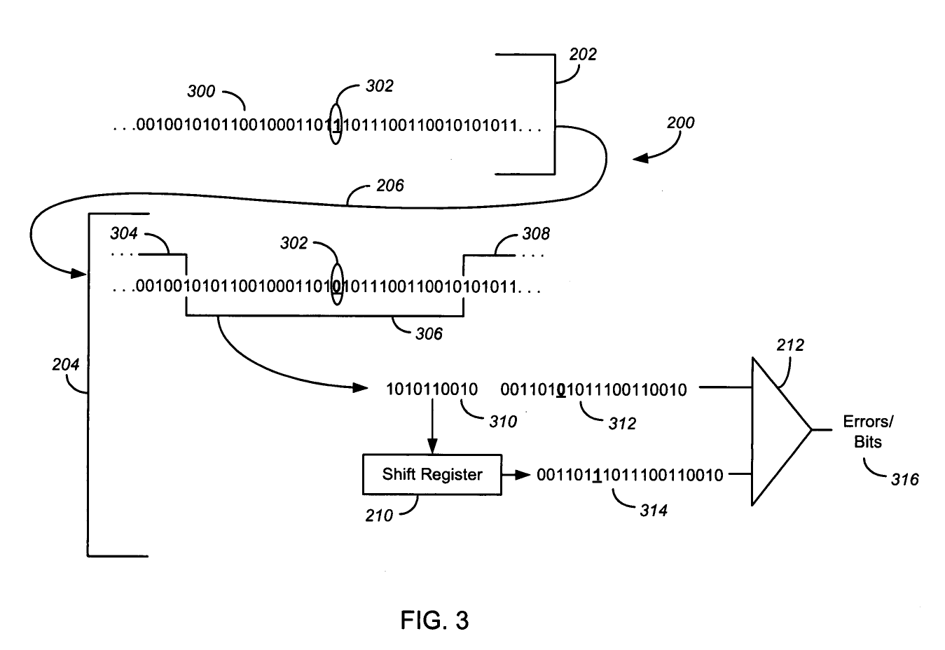

In accord with the method 100, a bitstream is generated in accord with a predetermined algorithm and sent 102 via the transmitting end 202 of the communication link 200. The bitstream is then received 104 via the receiving end 204 of the communication link 200 and, for each of a number of bit sets in the received bitstream, 1) a first number of bits in the bit set, and the predetermined algorithm, are used 106 to predict a second number of bits in the bit set, and 2) a bit error rate for the received bitstream is determined 108, in part, by comparing the predicted second number of bits to a corresponding second number of bits in the bit set. A first exemplary operation of steps 106 and 108 is illustrated in FIG. 3.

As shown in FIG. 3, the bitstream 300 is sent by the transmitting end 202 of the communication link 200. The bitstream 300 is then received by the receiving end 204 of the communication link 200. By way of example, the bitstream 300 is shown to comprise a bit 302 (i.e., a logic “1”) that is interpreted incorrectly at the receiving end 204 (i.e., interpreted as a logic “0”). One possible reason for the bit misinterpretation may be impedance irregularities in the line 206 connecting the transmitting and receiving ends 202, 204 of the communication link 200.

To identify the presence or absence of bit errors in the bitstream 300, the bitstream received at the receiving end 204 of the communication link 200 may be divided into a number of bit sets 304, 306, 308. In FIG. 3, these bit sets 304, 306, 308 are shown to consist of thirty (30) bits each. Each bit set 306 is further divided into a first number of bits 310 and a second number of bits 312. By way of example, FIG. 3 shows the first number of bits 310 to consist of ten (10) bits, and shows the second number of bits 312 to consist of twenty (20) bits.

Upon receipt, the first number of bits 310, in conjunction with knowledge of the predetermined algorithm that was used to generate the bitstream 300, can be used to generate a prediction 314 of the second number of bits 312. Thereafter, a bit error rate 316 for the bitstream 300 is determined, in part, by comparing the actual and predicted second number of bits 312, 314. If differences in the actual and predicted second number of bits 312, 314 are noted, all of the bits in the bit set 306 (i.e., thirty (30) bits) may be assumed to be erred, because it is not known whether the actual bit error or errors are in the first number of bits 310 or the second number of bits 312. This can result in reporting a larger error rate than would be reported if the actual bit in error was known, but guarantees that the bit error rate is no larger than what is reported. In practice, this is useful because it is sufficient for finding the “best” set of analog characteristics for the communication link 200.

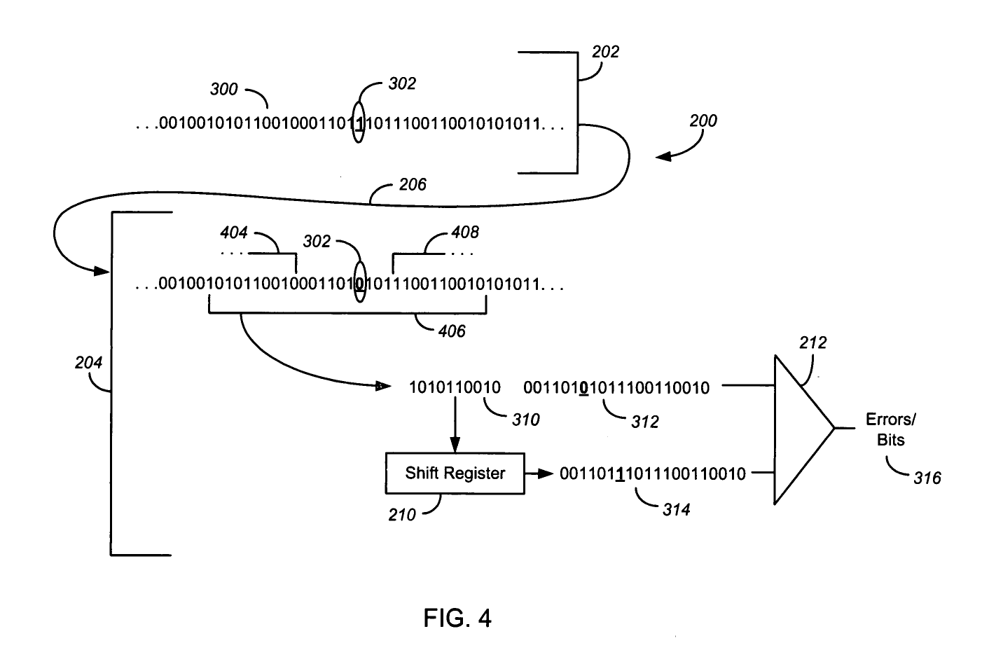

A second exemplary operation of steps 106 and 108 of the method 100 is illustrated in FIG. 4. In contrast to FIG. 3, which illustrates a case where the bitstream received at the receiving end 204 of the communication link 200 is divided into a plurality of non-overlapping bit sets 304, 306, 308 (i.e., for the purpose of identifying the presence or absence of bit errors in the bitstream 300), FIG. 4 illustrates a case where the bitstream received at the receiving end 204 of the communication link 200 is divided into overlapping bit sets 404, 406, 408. Although the amount of overlap between the bit sets 404, 406, 408 may vary, the bit sets 404, 406, 408 shown in FIG. 4 have been chosen so that the first ten (10) bits of a later bit set 406 overlap the last ten (10) bits of an earlier bit set 404. In this manner, and in the context of thirty (30) bit sets having ten (10) bit overlaps, it is possible to generate a bit error rate with a twenty (20) bit resolution instead of a thirty (30) bit resolution. This is because the overlap provides for 1) first determining whether there are any errors in the set of bits 310 that is used to make a prediction, and then 2) if there are no errors in the set of bits 310 that is used to make the prediction, determining whether there are any differences between the actual and predicted second numbers of bits 312, 314.

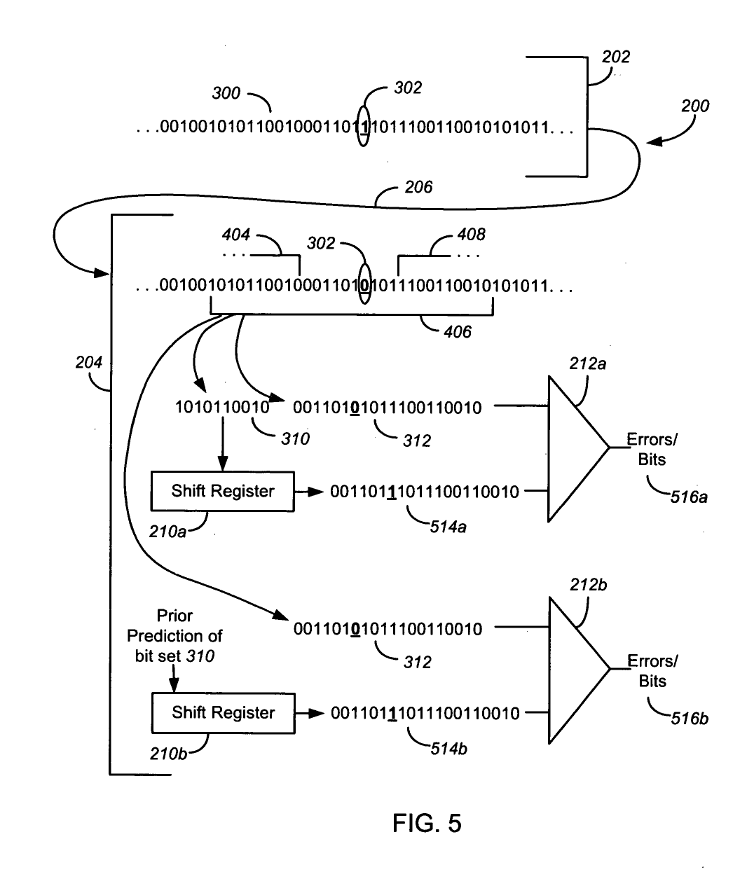

Higher bit error rate resolutions can also be achieved, but at the cost of greater data processing burdens. For example, a third exemplary operation of steps 106 and 108 of the method 100 is illustrated in FIG. 5.

As previously mentioned, and in accord with the error detecting techniques described in the above paragraphs, it is sometimes unknown whether an error or errors exist in the first or second number of bits 310, 312 of a bit set 306 (or 406). As a result, the actual bit error rate of a bitstream 300 may be over-estimated. One way to alleviate this is to make two predictions 514a, 514b of each set of received bits 312 (see FIG. 5). The first prediction 514a is based on the first number of bits 310 of a bit set 406, and may be generated by means of a shift register 210a. However, the second prediction 514b is based on a prior prediction of the bit set 310, and may be generated by means of a shift register 210b. The first prediction 514a is compared to the second number of bits 312 via a comparator 212a to generate a first bit error rate 516a; and the second prediction 514b is compared to the second number of bits 312 via a comparator 212b to generate a second bit error rate 516b. If both of the bit error rates 516a, 516b are zero, it can be assumed that the bit set 406 is “error free”. If only one of the bit error rates 516a, 516b is zero, it can be assumed that an error only exists in the first number of bits 310. If both of the bit error rates 51 6a, 516b are non-zero, then it can be assumed that a bit error exists in the second number of bits 312. If it is determined that an error exists in the second number of bits 312, a subsequent check for errors in the bit set 408 can be used to determine whether the error in the number of bits 312 is an error in the first or last ten bits of the bits 312 (e.g., by determining whether an error exists in the first ten bits of the bit set 408).

In some embodiments, the predetermined algorithm for generating the bitstream 300 is implemented via a first shift register with feedback 208, such as a linear feedback shift register (LFSR) or multiple-input shift register (MISR). See FIG. 2. The predetermined algorithm for predicting the second number of bits 312 may then be implemented via a second shift register with feedback 210 that is configured similarly to the first shift register with feedback 208. The comparison of the actual and predicted second number of bits 312, 314 in a bit set 306 may be made via a comparator 212.

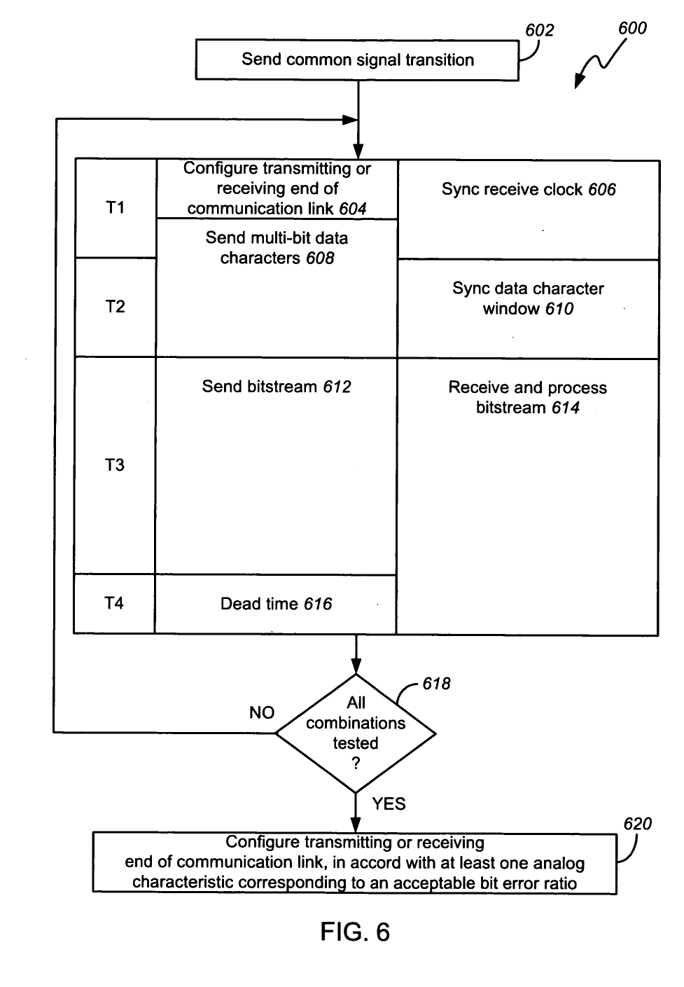

Building upon the method 100, FIG. 6 illustrates an exemplary method 600 for determining one or more acceptable analog characteristics for the communication link 200. The method 600 comprises the sending 612 and receiving 614 of a bitstream, similarly to the method 100. However, the method 600 also comprises steps 602, 604, 606, 608, 610 for synchronizing the receiving and transmitting ends 202, 204 of the communication link 200, as well as steps 618, 620 for determining one or more acceptable analog characteristics for the communication link 200.

The method 600 comprises one or more setup phases (step 602, and time periods T1 and T2) and one or more test phases (time periods T3 and T4, and steps 618 and 620). During the one or more setup phases, an optional common signal transition (e.g., an edge or pulse) may be sent 602 to both the transmitting and receiving ends 202, 204 of a communication link 200. The common signal transition can be used to start or reset the local clocks of the transmitting and receiving ends 202, 204—which can be especially useful in cases where a common BERT reference clock cannot be provided to both the transmitting and receiving ends 202, 204 of the communication link 200.

A receive clock of the communication link's receiving end 204 is then synced 606 to signal edges that are recovered from the communication link 200. In one embodiment, the receive clock is synced to miscellaneous clock edges that are generated by the transmitting end 202 of the communication link 200 while it configures itself for transmission of a bitstream.

While the receive clock is being synced to the recovered signal edges, and during a time period T1, at least one analog characteristic of the transmitting or receiving end 202, 204 of the communication link 200 may be configured 604 (or altered). In one embodiment, the at least one analog characteristic comprises a combination of a voltage differential and a pre-emphasis, both of which are imparted to a bitstream that is sent via the transmitting end 202 of the communication link 200.

After the transmitting end 202 (or receiving end 204) is configured 604, and beginning in time period T1, the transmitting end 202 may send 608 a plurality of multi-bit data characters over the communication link 200. The receiving end 204 then syncs 610 a data character window to the transmitted characters during time period T2. In one embodiment, the data character window is synced 610 by 1) segmenting received bits into data characters, in accord with a data character window, and 2) shifting the data character window until the data characters it produces coincide with one or more of the multi-bit data characters that were sent via the transmitting end 202 of the communication link 200. In one embodiment, the multi-bit data characters are 8B/10B encoded comma characters.

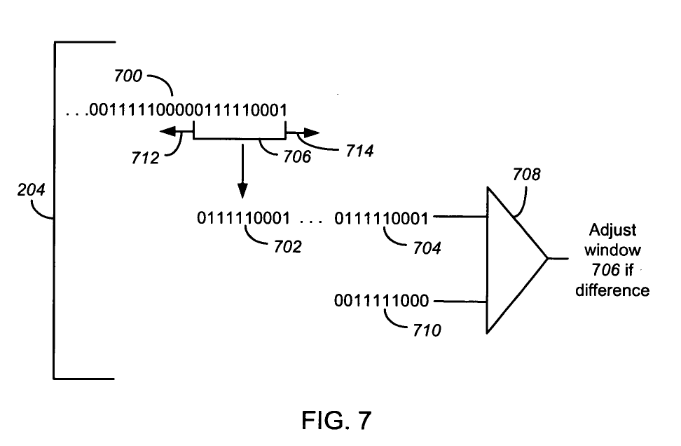

An exemplary operation of step 610 is illustrated in FIG. 7. As shown, the receiving end 204 receives a plurality of bits 700 and segments them into data characters 702, 704 in accord with a data character window 706. In FIG. 7, the data character window 706 is shown to be ten (10) bits long. The data characters 702, 704 produced by the data character window 706 are then compared (e.g., via a comparator 708) to one or more expected data characters 710 (e.g., an 8B/10B comma character) and, if the data characters 702, 704 produced by the data character window 706 are not identifiable, the data character window 706 is shifted with respect to the received bits 700 (e.g., in direction 712 or direction 714). This process is then repeated until the data characters 702, 704 produced by the data character window 706 appear as expected.

In some cases, step 606 is executed by syncing the receive clock of the receiving end 204 to signal edges of the data characters that are sent in step 608. Additionally, the time period T2 should be more than long enough to allow the data character window to sync to the transmitted characters. If the receiving end 204 is able to sync its data character window before the end of the period T2, it may proceed to the bitstream receiving mode shown in time period T3.

During time period T3, a bitstream is sent 612 and received 614 between the transmitting and receiving ends 202, 204 of the communication link 200. The received bitstream is also processed to determine a bit error rate (as described with respect to method 100).

A time period T4, providing a dead time 616, may be provided in case the local clock of the receiving end 204 is slower than the local clock of the transmitting end 202.

As indicated by decision block 618, the time periods T1-T4 may be repeated for different configurations of one or more analog characteristics of the transmitting or receiving ends 202, 204 of the communication link 200. Then, in response to the bit error rates determined for different ones of the bitstreams (i.e., bitstreams transmitted under different analog conditions), the transmitting or receiving end 202, 204 of the communication link 200 may be configured 620 in accord with the analog characteristic (or characteristics) corresponding to an acceptable bit error rate. Typically, the acceptable bit error rate will be the lowest bit error rate. However, factors besides bit error rate may sometimes dictate the choice of analog characteristics other than those that correspond to the lowest bit error rate. Or, when two sets of analog characteristics produce the same bit error rate (e.g., a zero rate), factors other than bit error rate may be relied on to select the best set of analog characteristics.

The sending of a bitstream (or bitstreams) in accord with the methods 100 or 600 may be initiated at various times, including 1) upon detection of a reconfiguration of the communication link 200, or 2) upon determining that a data error rate for the communication link exceeds a threshold.

By way of example, the actions of the methods 100 and 600 may be implemented via logic (e.g., an FPGA or ASIC), firmware or software. In the case of a transceiver (e.g., a serial/deserializer (SERDES)), both the transmit and receive functions of the method 100 or 600 may be implemented by a single device, thereby allowing the method 100 or 600 to be implemented in reciprocal directions between two like-configured transceivers.

Not only are the methods 100 and 600 capable of functioning without a common reference clock, but they are also “self-healing”. That is, given that the predetermined algorithm used to send a bitstream 300 (FIG. 3) can be recreated beginning with any bit of the bitstream 300, the methods 100 and 600 are capable of self-healing with every new set of bits 306 of a received bitstream.

What is claimed is:

1. A method for performing a bit error rate test, comprising:
via a transmitting end of a communication link, sending a bitstream that is generated in accord with a predetermined algorithm;
via a receiving end of the communication link,
receiving the bitstream; and
for each of a number of bit sets in the received bitstream, i) using a first number of bits in the bit set, and the predetermined algorithm, to predict a second number of bits in the bit set, and ii) determining a bit error rate for the received bitstream by comparing the predicted second number of bits to a corresponding second number of bits in the bit set.

2. The method for claim 1, further comprising:
prior to sending and receiving the bitstream,
sending a plurality of multi-bit data characters via the transmitting end of the communication link; and
via the receiving end of the communication link, i) segmenting received bits into data characters, in accord with a data character window, and ii) shifting the data character window with respect to the received bits until the data characters it produces coincide with one or more of the multi-bit data characters sent by the transmitting end of the communication link.

3. The method for claim 2, further comprising, prior to sending and receiving the multi-bit data characters, sending a common signal transition to the transmitting and receiving ends of the communication link.

4. The method for claim 2, further comprising, prior to sending and receiving the multi-bit data characters, syncing a receive clock of the receiving end to signal edges recovered from the communication link.

5. The method for claim 2, wherein the plurality of multi-bit data characters consists of 8B/10B encoded comma characters.

6. The method for claim 1, further comprising:
sending and receiving, and updating a bit error rate for, a plurality of bitstreams; and
between sending each of the bitstreams, altering at least one analog characteristic of the transmitting or receiving end of the communication link.

7. The method for claim 6, wherein the at least one analog characteristic comprises a combination of a voltage differential and a pre-emphasis, imparted to the transmitted bitstreams at the transmitting end of the communication link.

8. The method for claim 6, further comprising, in response to the bit error rates determined for different ones of the bitstreams, configuring the transmitting end of the communication link in accord with the at least one analog characteristic corresponding to an acceptable bit error rate.

9. The method for claim 6, further comprising, in response to the bit error rates determined for different ones of the bitstreams, configuring the receiving end of the communication link in accord with the at least one analog characteristic corresponding to an acceptable bit error rate.

10. The method for claim 6, further comprising, initiating the sending of the bitstreams upon detection of a reconfiguration of the communication link.

11. The method for claim 6, further comprising, initiating the sending of the bitstreams upon determining that a data error rate for the communication link exceeds a threshold.

12. The method for claim 1, further comprising:
implementing the predetermined algorithm at the transmitting end via a first shift register with feedback; and
implementing the predetermined algorithm at the receiving end via a second shift register with feedback, the second shift register with feedback being configured similarly to the first shift register with feedback.

13. The method for claim 1, wherein each of the number of bit sets consists of thirty bits, with the first number of bits of each bit set consisting of ten bits, and with the second number of bits of each bit set consisting of ten bits.

14. A method for determining one or more acceptable analog characteristics for a communication link extending between a transmitting end and a receiving end, the method comprising:
during one or more setup phases,
syncing a receive clock of the receiving end to signal edges recovered from the communication link;
sending a plurality of multi-bit data characters via the transmitting end; and
via the receiving end, segmenting received bits into data characters, in accord with a data character window and, after syncing the receive clock, shifting the data character window with respect to the received bits until the data characters it produces coincide with one or more of the multi-bit data characters sent by the transmitting end of the communication link;
during one or more test phases,
via the transmitting end of the communication link, sending a plurality of bitstreams that are generated in accord with a predetermined algorithm; and
via the receiving end of the communication link,
receiving each bitstream; and
for each received bitstream, and for each of a number of bit sets in the received bitstream, i) using a first number of bits in the bit set, and the predetermined algorithm, to predict a second number of bits in the bit set, and ii) determining a bit error rate for the received bitstream by comparing the predicted second number of bits to a corresponding second number of bits in the bit set;
during the one or more setup phases, and between sending each of the plurality bitstreams, altering at least one analog characteristic of the transmitting or receiving end of the communication link; and
in response to the bit error rates determined for different ones of the bitstreams, configuring the transmitting or receiving end of the communication link in accord with the at least one analog characteristic corresponding to an acceptable bit error rate.

15. The method for claim 14, further comprising, prior to sending and receiving the multi-bit data characters, sending a common signal transition to the transmitting and receiving ends of the communication link.

16. The method for claim 14, wherein the at least one analog characteristic comprises a combination of a voltage differential and a pre-emphasis, imparted to the transmitted bitstreams at the transmitting end of the communication link.

17. Apparatus, comprising:
a receiver; and
logic to,
receive, via the receiver, a first plurality of bitstreams that are generated in accord with a predetermined algorithm; and
for each received bitstream, and for each of a number of bit sets in the received bitstream, i) use a first number of bits in the bit set, and the predetermined algorithm, to predict a second number of bits in the bit set, and ii) determine a bit error rate for the received bitstream, in part, by comparing the predicted second number of bits to a corresponding second number of bits in the bit set.

18. The apparatus of claim 17, further comprising logic to, via the receiver, and prior to receiving each of the first plurality of bitstreams,
sync a receive clock of the receiver to signal edges recovered from a communication link to which the receiver is coupled;
segment received bits into data characters, in accord with a data character window; and
shift the data character window with respect to the received bits until the data characters it produces coincide with one or more multi-bit data characters.

19. The apparatus of claim 17, further comprising:
a transmitter; and
logic to,
send, via the transmitter, each of a second plurality of bitstreams generated in accord with the predetermined algorithm; and
between sending each of the second plurality of bitstreams, alter at least one analog characteristic of a communication link to which the transmitter is coupled.

20. The apparatus of claim 19, further comprising logic to, prior to sending the second plurality of bitstreams, send a plurality of multi-bit data characters via the transmitter.

21. The apparatus of claim 20, wherein the plurality of multi-bit data characters consists of 8B/10B encoded comma characters.

22. The apparatus of claim 19, further comprising:
a first shift register with feedback to implement the predetermined algorithm for predicting the second numbers of bits in the bit sets; and
a second shift register with feedback, configured similarly to the first shift register with feedback, to implement the predetermined algorithm for generating the second plurality of bitstreams.
